(19) United States
(12) Patent Application Publication
(10) Pub. No.: US 2015/0294361 A1
(43) Pub. Date: Oct. 15, 2015

(54) METHOD AND SYSTEM FOR OFFERING MERCHANT SERVICES AND INFORMATION THROUGH A COMMON INTERFACE

(71) Applicant: VONAGE NETWORK LLC, Holmdel, NJ (US)

(72) Inventor: Reut Yedidim, Rosh-Haayin (IL)

(73) Assignee: VONAGE NETWORK LLC, Holmdel, NJ (US)

(21) Appl. No.: 14/250,599

(22) Filed: Apr. 11, 2014

(51) Int. Cl. G06Q 30/02; H04W 4/02; G06Q 20/32; G06Q 20/40

(52) U.S. Cl. CPC G06Q 30/0261; G06Q 20/40; H04W 4/021; G06Q 20/322

(57) ABSTRACT

Methods and systems for providing services and information for multiple business entities through a single application that provides a convenient and common interface are provided herein. In some embodiments, a method for providing information and services to a user device may include receiving, by an interactive business card server of a service provider, information from each of a plurality of business entities via an application programming interface, receiving information associated with a user device from a service provider application installed on the user device and registered with the service provider, determining that the user device is in geographic proximity of one of the plurality of business entities based on the information received, and sending an interactive business card including at least some of the information associated with the one of the plurality of business entities in a format that can be displayed by the service provider application.

### BACKGROUND

1. Field

Embodiments of the present invention generally relate to communication services, and specifically, to methods and systems for providing services and information for multiple business entities through a single application that provides a convenient and common interface.

2. Description of the Related Art

Conventional methods for purchasing of goods within a retail establishment may be inconvenient and/or inefficient. Customers may only be able to see a portion of a menu of goods/services from a location within the retail establishment or find copies of possible outdated printed menus. In addition, customers must also wait in line to place an order with a business associate as well as remember to bring a loyalty card and payment method accepted by each particular business entity visited by the customer.

To help retail shoppers, merchants have each developed respective proprietary software applications to be individually downloaded by customers. The applications may track loyalty program statuses, rewards, provide payment options, track purchases, and are intended to make shopping for goods and services easier for customers. However, each individual application must be separately downloaded, stored, and registered. The applications thus become burdensome to navigate and as well as inefficiently require additional memory storage.

Furthermore, smaller merchants may not be large enough to develop their own applications and are thus limited from supplying such robust featured applications to their customers.

What is needed is a method and system that uniformly supplies services for multiple business entities through a single application as well as provides a convenient interface.

### SUMMARY

Embodiments of the present invention generally relate to methods and systems for providing services and information for multiple business entities through a single application that provides a convenient and common interface. In some embodiments, a method for providing information and services to a user device may include receiving, by an interactive business card server of a service provider, information from each of a plurality of business entities via an application programming interface (API), receiving a first set of information associated with a user device from a service provider application installed on the user device and registered with the service provider, determining that the user device is in geographic proximity of one of the plurality of business entities based on the information received, and sending an interactive business card including at least some of the information associated with the one of the plurality of business entities in a format that can be displayed by the service provider application.

In some embodiments, a method for receiving information and service associated with one or more business entities may include establishing, via a first user device, a wireless connection with a network access point associated with a first business entity, sending, by a service provider application installed on the first user device, user account information and geolocation information to a remote server via the wireless connection, receiving, by the service provider application, an interactive business card including information and services associated with the first business entity, and displaying, using the service provider application, the interactive business card received.

In some embodiments, a system for providing information and services to a user device may include an interactive business card application programming interface (API) configured to receive information from each of a plurality of business entities, and an interactive business card generation module configured to receive a first set of information associated with a user device from a service provider application installed on the user device and registered with a service provider, determine that the user device is in geographic proximity of one of the plurality of business entities based on the information received, and sending an interactive business card including at least some of the information associated with the one of the plurality of business entities in a format that can be displayed by the service provider application.

Various advantages, aspects and novel features of the present disclosure, as well as details of an illustrated embodiment thereof, will be more fully understood from the following description and drawings. Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an exemplary diagram of a system for providing services and information for multiple business entities through common interface in accordance to one or more embodiments of the present invention;

FIG. 2 is an exemplary block diagram of a user device and interactive business card server in accordance with one or more embodiments of the present invention;

FIG. 3 is an exemplary flowchart of a method for processing and presenting business card data using the interactive business card server in accordance with one or more embodiments of the present invention;

FIG. 4 is an exemplary flowchart of a method for processing and presenting business card data for a user device in accordance with one or more embodiments of the present invention;

FIG. 5 is an exemplary interactive business card rendered on the user device in accordance with one or more embodiments of the present invention; and

FIG. 6 is an exemplary diagram of a computer system for offering services associated with a shared access point in accordance with one or more embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to methods and systems for providing services and information for multiple business entities through a single application that provides a convenient and common interface.

While the embodiments discussed herein may include mobile devices using mobile communications, additional embodiments include fixed electronic devices (e.g., desktop computers and corded phones). One non-limiting form of mobile communications that may be used with embodiments described herein is Voice over IP (VoIP), which is utilized to establish and provide voice communications over a data network using the Internet Protocol (IP). Businesses and individuals implement VoIP by installing the necessary equipment, software, and service (i.e., a “high speed” network or broadband connection) to access a VoIP service provider and activating this telecommunication service. Calls from a VoIP subscriber device to a destination device may be routed via a number of inter-connected networks, such as via a VoIP service provider network, mobile telephone service provider networks (e.g., 3G, Long Term Evolution (LTE)), and existing and traditional telecommunications systems that is more commonly referred to as the Public Switched Telephone Network (PSTN) or Plain Old Telephone Service (POTS).

VoIP service providers may provide mobile or desktop VoIP applications (apps) that users can install on their smartphone or other type of mobile or stationary computing devices, or may provide VoIP Telephone/Device Adaptors (TA) that can be used with traditional hardwire telephones. Such VoIP apps are typically over the top (OTT) VoIP applications (e.g., software applications for mobile, tablet or other similar portable electronic devices that are capable of providing communication services from a provider other than that typically associated with the portable electronic device).

At least a portion of the call may be transmitted as packets over an IP network, via Wi-Fi for example, rather than over traditional channels (e.g., the voice channel on a 2G or 3G network, or the like). By transmitting voice as packet data over an IP network, these mobile apps can allow a user to make calls to another OTT client or an off-net destination. They may be used when the user is connected to a base station over the mobile operator's cell network, over a third-party's Wi-Fi access point, over WIMAX, and the like.

In the following description, the terms “business entity” and “merchant” may generally describe entities that provide goods or services to consumers and the computers systems that operate on behalf of those entities. The computer systems may be located on-site at the business entity (e.g., coffee shop franchisee, physician's office, grocery store and the like) as well as off-site on a corporate server farm. Computers on-site may also include point of sale systems and merchandising systems that typically would be used by a business entity to process an order or service ticket entered in-person.

User devices (e.g., end-user devices) generally refer to devices operated by consumers that are utilized with interfacing with either a remote server through the shared access point or directly with the access point. The user devices have a communication application installed that is also configured to process an interactive business card for offering services associated with a shared access point.

“Shared access point” shall refer to the individual as well as multiple wireless access points in a common network (e.g., Wi-Fi, near field communications (NFC), BLUETOOTH, IBEACON, Radio-frequency identification (RFID), and the like). Location data for the user device may be determined by global position systems (GPS), geo-fencing, and internet protocol (IP) registration, DNS lookup, or a combination thereof.

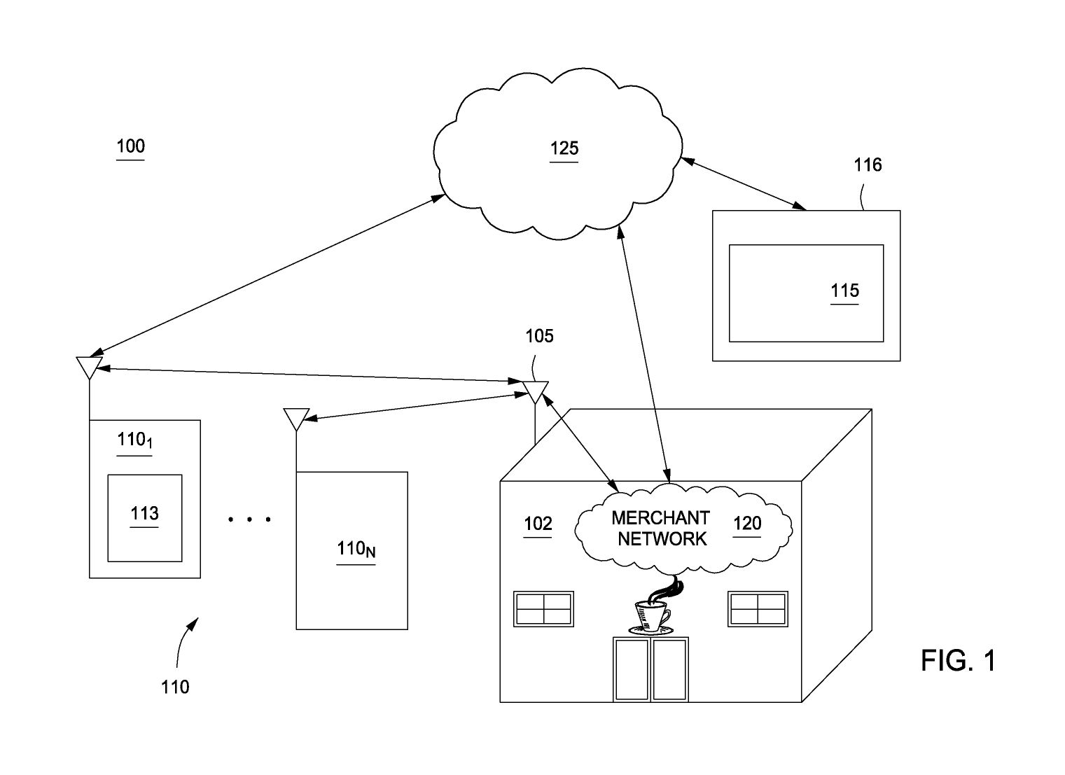

FIG. 1 is an exemplary diagram of an interactive business card (IBC) system 100 that can push interactive business cards (IBCs) to end-user devices in accordance to one or more embodiments of the present invention. In some embodiments, the interactive business card system 100 includes a remote interactive business card (IBC) server 115 that stores an application programming interface (API) that may be accessed by multiple different business entities. Individual business entities may communicate through the API to send information for various commercial goods and services offerings to user devices detected as in proximity to the business entity. The remote IBC server 115 may be part of an IBC service provided by a telecommunication service provider 116, such as for example, a VoIP service provider. Merchants/business entities that register for the IBC service with service provider 116 and referred to as IBC enabled merchants (e.g., business entity 102). The IBC server 115 generates IBCs using the information provided by the IBC enabled merchants. The IBCs facilitate the purchase of goods and services, or to provide merchant information, on the user device. The business cards may subsequently be stored on the user device and may be forwarded to other user devices through the IBC server or via other communication methods (i.e., short messaging service (SMS) messages, email, etc.) direct from the user device 110.

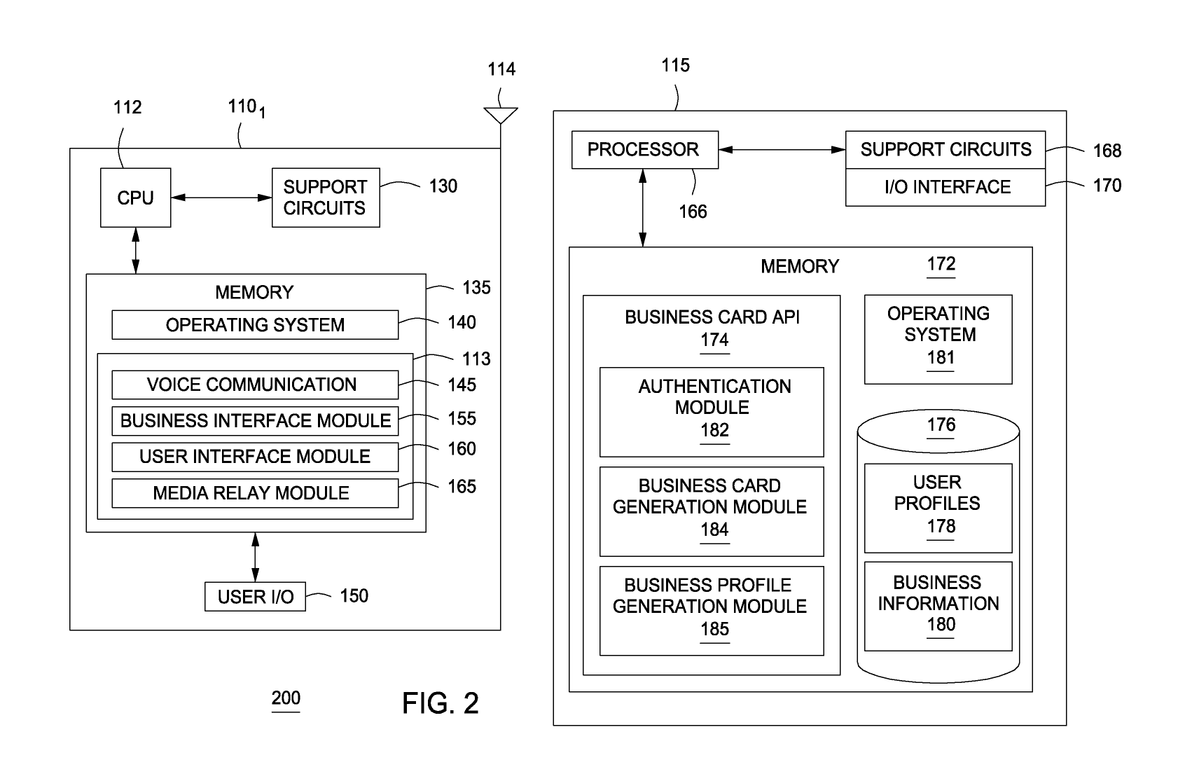

As shown in FIG. 1, the IBC system 100 includes one or more a user devices 110 communicatively coupled to a shared access point 105 (e.g., a WiFi access point, and the like) of a business entity 102. The user device 110₁ includes a service provider application 113, such as a VoIP telecommunication application, that includes IBC modules (i.e., an IBC enabled application), as described below with respect to FIG. 2, for displaying and interacting with IBCs provided and is referred herein as an IBC enabled device. The service provider application 113 may be registered with the service provider and may include user account information which authorizes the service provider application 113 and user device 110₁ to access services provided by the service provider. In some embodiments, the shared access point 105 provides access to a merchant network 120 which is communicatively coupled to a larger communications network 125 (e.g., the Internet). The communications network 125 is communicatively coupled to the IBC server 115 which, in some embodiments, may be disposed on a telecommunication service provider network.

The communications network 125 comprise one or more communication systems that connect computers by wire, cable, fiber optic and/or wireless link facilitated by various types of well-known network elements, such as hubs, switches, routers, and the like. The networks 125 may include an Internet Protocol (IP) network, a public switched telephone network (PSTN), or other mobile communication network, and may employ various well-known protocols to communicate information amongst the network resources. The user devices 110 may be electronic user devices (e.g., telephones, personal computers, laptops, smart phones, mobile phones, tablets, smart TVs, and the like).

In some embodiments, the merchant network 120 registers a geographic location with the business card server 115. The geographic location may be in the form of a physical street address, GPS coordinates, and the like. The geographic location of the merchant may be manually provided to and registered with the IBC server 115, or automatically through GPS, DNS lookup and the like.

In some embodiments, the IBC server 115 will determine when an IBC enabled device 110₁ enters a geographic area of an IBC enabled merchant 102 (i.e., when an IBC enabled device 110₁ is within geographic proximity of an IBC enabled merchant 102). For example, in some embodiments, the IBC enabled service provider application 113 will send geolocation information (e.g., GPS coordinates or the like) to the IBC server 115. The IBC server 115 will compare by the location information of device 110₁ received with the location information of the IBC enabled merchant 102 to determine if the IBC enabled device 110₁ is in geographic proximity of an IBC enabled merchant 102. In some embodiments, the geolocation information will be sent via merchant network 120 and communication network 125 to the IBC server 115, while in other embodiments, the geolocation information is sent directly to IBC server 115 via communication network 125 by IBC enabled device 110₁. Once the geolocation information is received, the IBC server 115 may search for IBC enabled merchants located in proximity to the IBC enabled device's location.

In some embodiments, the IBC server 115 will be notified when an IBC enabled device 110₁ is in geographic proximity of an IBC enabled merchant 102. For example, in some embodiments, the IBC enabled service provider application 113, or a local computer system on merchant network 120, will send a notification to the IBC server 115 when the IBC enabled device 110₁ connects to the shared access point 105. The notification may include a unique identifier of the IBC enabled device 110₁ (e.g., a phone number, a user account number, a MAC address, an IMEI, and the like) and/or a unique identifier of shared access point 105 (e.g., IP address, MAC address, and the like). Thus, in some embodiments, the IBC server 115 does not need to search for the IBC enabled merchants located in proximity to the location of the IBC enabled device 110₁ because the specific access point 105 is already associated with a specific IBC merchant.

In some embodiments, the notification may also include location information and other information associated with either the IBC enabled device 110₁ or the IBC enabled merchant 102. In some embodiments, the notification may be sent using Transmission Control Protocol (TCP), User Datagram Protocol (UDP), Session Initiation Protocol (SIP), and the like.

In some embodiments, the IBC enabled service provider application 113 will send user account information to authenticate the user account associated with the service provider application 113 prior to performing any location determination operations or IBC sending operations. In some embodiments, the user account information may be the same user account information associated with a telecommunication service provided by the server provider.

Once it is determined that an IBC enabled device 110₁ is within geographic proximity of an IBC enabled merchant 102, and IBC will be pushed to the IBC enabled device 110₁. The information and the format of the IBC that is stored on the IBC server and pushed to the IBC enabled device 110₁ is originally provided by the IBC enabled merchant 102 through an API on the IBC server 115. IBC offerings may include goods, services, coupons, loyalty programs, user specific deals, and the like. The IBC server 115 subsequently formats and generates the information into the IBC that is sent to the user device 110. The user device 110 then displays the business card through the graphical user interface (GUI) to a user.

In some embodiments, the IBC enabled merchant 102 may directly send local information via local computer system on merchant network 120 to the user device 110 in addition to the interactive business card. In such an embodiment, the local computer system on merchant network 120 stores business card data that is subsequently generated on the IBC enabled device 110₁. In such embodiments, the IBC enabled merchant 102 may locally store portions of the interactive business card to conserve bandwidth and repetitious downloading from the IBC server 115. These portions are common and generic to multiple user devices (e.g., store name, date, drink menu, and the like). The portions are subsequently sent along with user specific data (e.g., rewards status, promotions, and the like) from the IBC server 115 to the user device to form a combined interactive business card on the IBC enabled device 110₁. The business entity 102 may update stored portions repeatedly (e.g., once an hour, once, a day, and the like).

In some embodiments, the IBC server 115 also coordinates payment systems using stored payment data of the user account associated with the IBC enabled device 110₁. In such an embodiment, the IBC server 115 performs as an intermediary for purchasing from bank accounts or credit card handling. Upon completion of a transaction, the IBC server 115 notifies both the IBC enabled device 110₁ and IBC enabled merchant 102.

FIG. 2 is an exemplary block diagram of an IBC enabled device 110₁ and an interactive business card (IBC) server 115 in accordance with one or more embodiments of the present invention.

The IBC enabled device 110₁ comprises an antenna 114, a CPU 112, support circuits 130, memory 135, and user input/output interface 150. The CPU 112 may comprise one or more commercially available microprocessors or microcontrollers that facilitate data processing and storage. The various support circuits 130 facilitate the operation of the CPU 112 and include one or more clock circuits, power supplies, cache, input/output circuits, and the like. The memory 135 comprises at least one of Read Only Memory (ROM), Random Access Memory (RAM), disk drive storage, optical storage, removable storage and/or the like.

The support circuits 130 include circuits for interfacing the CPU 112 and memory 135 with the antenna 114 and I/O interface 150. The I/O interface 150 may include a speaker, microphone, additional camera optics, touch screen, buttons and the like for a user to interact with the shared access point 105.

The memory 135 stores an operating system 140 and an installed service provider application 113. In some embodiments, the installed service provider application 113 is a telecommunications application. The installed service provider application 113 comprises a voice communication module 145, business interface module 155, user interface module 160, and media relay module 165. The installed service provider application 113 coordinates communication among these modules to generate and communicate data from an IBC.

The operating system (OS) 140 generally manages various computer resources (e.g., network resources, file processors, and/or the like). The operating system 140 is configured to execute operations on one or more hardware and/or software modules, such as Network Interface Cards (NICs), hard disks, virtualization layers, firewalls and/or the like. Examples of the operating system 140 may include, but are not limited to, LINUX, CITRIX, MAC OSX, BSD, UNIX, MICROSOFT WINDOWS, WINDOWS MOBILE, IOS, ANDROID and the like.

The operating system 140 controls the interoperability of the support circuits 130, CPU 112, memory 135, and the I/O interface 150. The user interface module 160 contains instructions for the I/O interface 150 to interact with the operating system 140 such as for a graphical user interface (GUI). The voice communication module 145 may establish a communication session via cellular communication (e.g., CDMA, GSM, and the like) or Wi-Fi (e.g., VoIP). The user interface module 160 coordinates data from the business interface module and user I/O interface 150.

The business interface module 155 communicates with the IBC server 115 through the shared access point 105 and merchant network 120, or directly via communication network 125. In some embodiments, the business interface module 155 may also communicate directly with the business entity 102 through the shared access point 105 (e.g., a WIFI access point, and NFC access point, and the like) for information from the business. In further embodiments, a combination of data from the IBC server 115 and the IBC enabled merchant 102 may be communicated to the business interface module 155.

The business interface module 155 coordinates data from the IBC server 115 to generate an interactive business card on the IBC enabled device 110₁. The business interface module 155 also processes selections and payments made on the IBC enabled device 110₁. The resultant selection data is then sent to the IBC server 115 or business entity directly. In exchange, the business interface module 155 coordinates with the IBC server 115 to generate a code, confirmation number, QR code or the like as proof of purchase that may be scanned or captured by the IBC enabled merchant 102.

In other embodiments, selections may include real-time communication through email, chat, and voice calls through a “push to communicate” function. In such a function, as will be described further below, a user selects a communication channel (i.e., a type of communication service to use) on the interactive business card. In some embodiments, the user may select displayed data to open a communication channel. For example, selecting a displayed business number prompts a VoIP call to the number.

In an optional embodiment, the media relay module 165 streams, or otherwise sends, data from the IBC enabled device 110₁ to other user devices 110_{N}. In such an embodiment, the user device 110 may broadcast to other user devices 110_{N} a current location of the IBC enabled device 110₁. For example, the IBC enabled device 110₁ may be located in a STARBUCKS and automatically notify a predetermined group of people (e.g., a user's family) of the location. Continuing the example, the IBC enabled device 110₁ may forward the downloaded IBC such that the other user devices 110_{N} can submit orders. In some embodiments the orders are aggregated at IBC enabled device 110₁ or sent separately to the IBC server 115. The IBC server 115 processes the additional order data to facilitate purchasing such that the IBC enabled device 110₁ becomes authorized to accept the order at the business entity 102. The IBC server 115 may send the IBC enabled device 110₁ a QR code bearing identification information at the point of purchase.

The IBC server 115 comprises a processor 166, support circuits 168, I/O interface 170, and memory 172. The processor 166 may comprise one or more commercially available microprocessors or microcontrollers that facilitate data processing and storage. The various support circuits 130 facilitate the operation of the processor 166 and include one or more clock circuits, power supplies, cache, input/output circuits, and the like. The memory 172 comprises at least one of Read Only Memory (ROM), Random Access Memory (RAM), disk drive storage, optical storage, removable storage and/or the like.

The memory 172 stores a business card API 174, operating system 181, and database 176. The operating system (OS) 181 generally manages various computer resources (e.g., network resources, file processors, and/or the like). The operating system 181 is configured to execute operations on one or more hardware and/or software modules, such as Network Interface Cards (NICs), hard disks, virtualization layers, firewalls and/or the like. Examples of the operating system 181 may include, but are not limited to, LINUX, CITRIX, MAC OSX, BSD, UNIX, MICROSOFT WINDOWS, IOS, ANDROID and the like.

The database 176 stores user profiles 178 and business information 180. Business information 180 may be manually or automatically entered and updated by a plurality of business entities. Business information 180 includes commercial interaction information data for each business entity 102 such as: address, email, phone number, accepted forms of payment, payment systems, offerings, and the like. User profiles 178 store user purchasing data such as: the user name, address, past purchases, memberships, loyalty rewards, and the like.

The business card API 174 comprises an authentication module 182, business card generation module 184, and in some optional embodiments, a business profile generation module 185. The authentication module 182 verifies a user device 110 seeking to connect to the IBC server 115 matches an existing user profile 178. Non-members may be prompted to register and enter user data to create a new user profile with the IBC server 115.

The business card generation module 184 correlates the user profile with that of the business information 180 to generate a personalized interactive business card for the user device 110. Interactions generated include functions for communication and purchasing. For example, the business card generation module 184 may link a phone number in the business information 180 to a VoIP selectable object function. In another example, the business card generation 184 populates a selectable menu to present the user with offerings from the business entity 102. In yet another example, the business card generation module 184 may highlight previously ordered selections or current promotions/deals (e.g., buy one get one free, 30% Off Sale and the like).

The business card generation module 184 receives location data by correlating registered IP addresses associated with the business entity or shared access point. In one example, the business card generation module 184 uses the location data to customize the interactive business card for a specific business franchise. In another example, the location information is used to broadcast to other user devices 110_{N} that the user device 110 is in proximity of the business entity 102. In yet another example, the location data may be used to generate offerings from nearby businesses that include common offerings often purchased together.

In some embodiments, the business card generation module 184 may process payment systems for selections made on the user device 110. After processing, the business card generation module 184 sends a confirmation to the user device 110 and business entity 102. The confirmation may include a QR code. The business card generation module 184 may also process and aggregate queries from multiple user devices 110_{N} notified that the user device 110 is in proximity of the business entity 102.

The business profile generation module 185 builds a profile for a business entity 102. The profile may include franchise data for corporate companies that may provide product fulfillment from multiple local stores. In other embodiments, the profile includes identification data of shared access points where multiple access points are connected in a shared network. The business profile generation module 185 also generates a physical address mapped to an IP address associated with the business entity from the business information 180.

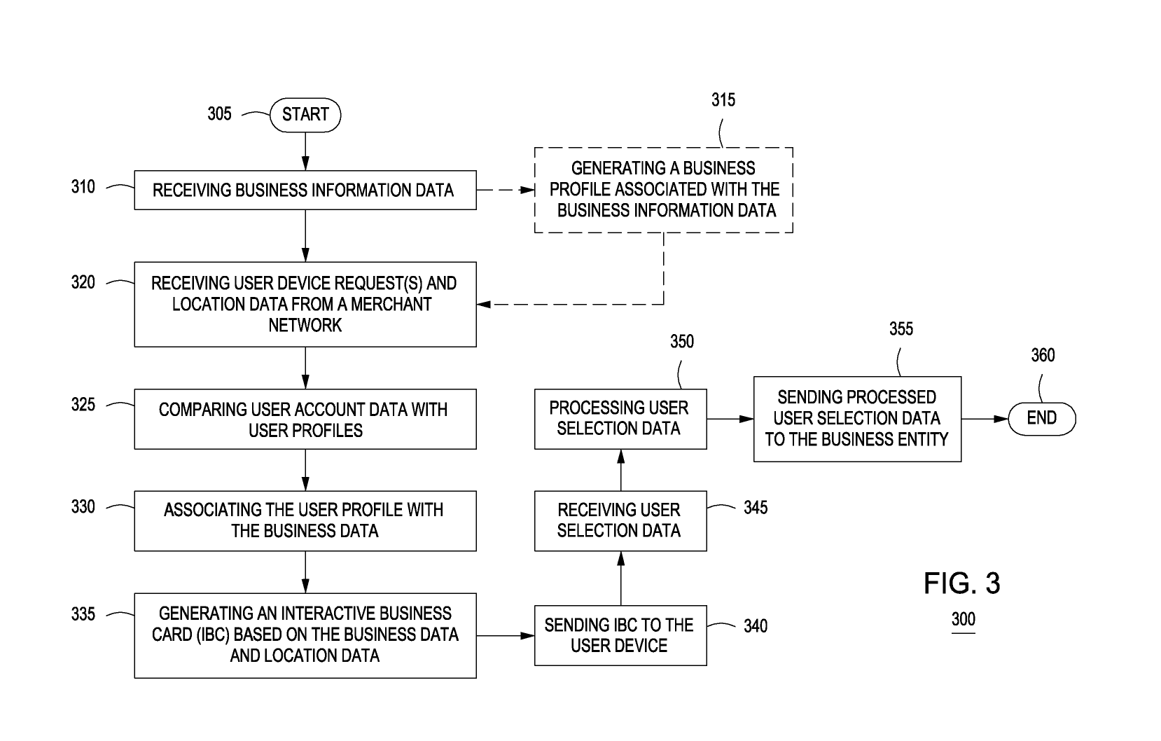

FIG. 3 is an exemplary flowchart of a method 300 for processing and presenting business card data using the interactive business card server 115 in accordance with one or more embodiments of the present invention.

The method 300 begins at step 305 and continues to step 310. At step 310, an API on the IBC server 115 receives business information data 180. The business information data includes generic business information (e.g., address, phone number, menu offerings, and the like), accepted payment systems, point of sale (POS) system, supply chain system and data formatting, temporary promotional data, loyalty program data for customers. In an optional step 315, the information data 180 is used to generate a business profile for the business entity associated with the business information data 180.

Next at step 320, the method 300 receives a request from at least one user device and location data via the merchant network 120 and/or shared access point 105 of the business entity 102. The request may include sending data containing user identification information. In some embodiments, the location data is predetermined and stored on the IBC server 115. In other embodiments, the data is substantially instantaneously determined via GPS, cellular triangulation, geo-fencing, or a combination thereof for real-time positioning and sent to the IBC server 115.

Next at step 325, the user device is authenticated by comparing the user account associated with the user device to a database in the IBC server 115 storing user profiles. In an optional embodiment, the user device may be prompted to create a user profile if none is found.

Next at step 330, the matching user profile data is associated with the business data 330. The association recalls stored user data corresponding to past purchases, rewards, promotions, discounts, and user specific data.

Next at step 335, an interactive business card (IBC) is generated for the specific user device 110 and user profile. The IBC is based on business data 180, associated user profile data 178, and location data.

In other embodiments, the IBC may include business data from multiple business entities such that related entities in the same relative geographical location can present shared offerings to a single user device for a synergistic effect. Subsequently, the user device is able to choose and/or purchase multiple offerings from multiple business entities on a single screen. For example, a coffee shop may include an option or deal to order from a doughnut store across the street.

At step 340, the IBC is sent to the user device via the shared access point 105 or directly via communication network 125. In some embodiments, the shared access point is one of multiple access points coupled in a merchant network 120.

At step 345, selection data from the user device is received that is then processed at step 350. The IBC server 115 through the API at step 350 may process selection data for facilitating purchasing of services or products selected in the IBC as offered by the business entity 102. Processing also includes formatting the data for the business entity 102 and user device 110. For example, the IBC server 115 formats data specifically for a smart phone with an application installed utilizing a business interface module 155 and the native point of sale processing system unique to the business entity 102.

At step 355, the processed user selection data is sent to the business entity 102. Processed user selection data may include confirmation of payment completion or simply order information formatted to the native purchasing system at the business entity point of sale. By formatting for the purchasing system, the IBC can supply seamless orders to the business entity 102. The method 300 then ends at step 360.

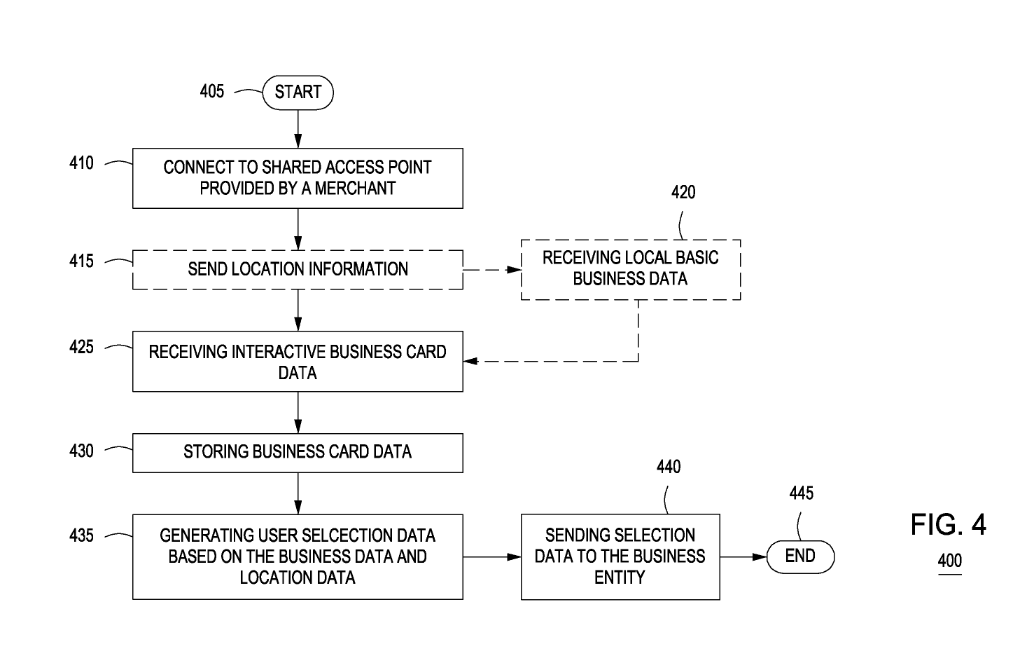

FIG. 4 is an exemplary flowchart of a method 400 for processing and presenting business card data for a user device 110 in accordance with one or more embodiments of the present invention.

The method 400 begins at step 405 and continues to step 410. At step 410, an IBC enabled user device 110₁ connects to a shared access point provided by an IBC enabled merchant 102.

Next at step 415, the IBC enabled user device 110₁ may send information to IBC server 115 via service provider application 113, for example. The information sent may include user account information to authenticate a user account to access services of the service provider. The information sent may also include geolocation information or a notification that the IBC enabled user device 110₁ is in geographic proximity of an IBC enabled merchant 102 (e.g., that user device 110₁ entered the merchant established) to IBC server 115. In some embodiments, the IBC enabled merchant 102 may send the notification/location information to IBC server 115. Optionally, the method 400 may continue to step 420. At step 420, the user device receives business information data locally directly through the shared access point, merchant network 120, or NFC. Step 420 allows immediate site specific data to be sent to the user device 110. For example, local business data may include data to immediately update a user device that a selection is not available or out of stock for the day at a local coffee shop.

Next at step 425, the IBC enabled user device 110₁ receives IBC data from the IBC server 115, either direct via communication network 125 or through merchant network 120. Continuing to step 430, the IBC data is stored on memory in the user device.

Next at step 435, the IBC enabled user device 110₁ generates user selection data from selections made by the user in the IBC presented on the IBC enabled user device 110₁. The IBC is personalized to the user profile associated with the IBC enabled user device 110₁ and the business entity 102.

Next at step 440, selection data of objects selected in the IBC is sent to the IBC enabled merchant 102. In some embodiments, the selection data may be indirectly formatted first by sending the selection data to the IBC server 115, and then to the IBC enabled merchant 102. In other embodiments, the user device 110 may format the selection data and directly send the selection data to the IBC enabled merchant 102. The method 400 then ends at step 445.

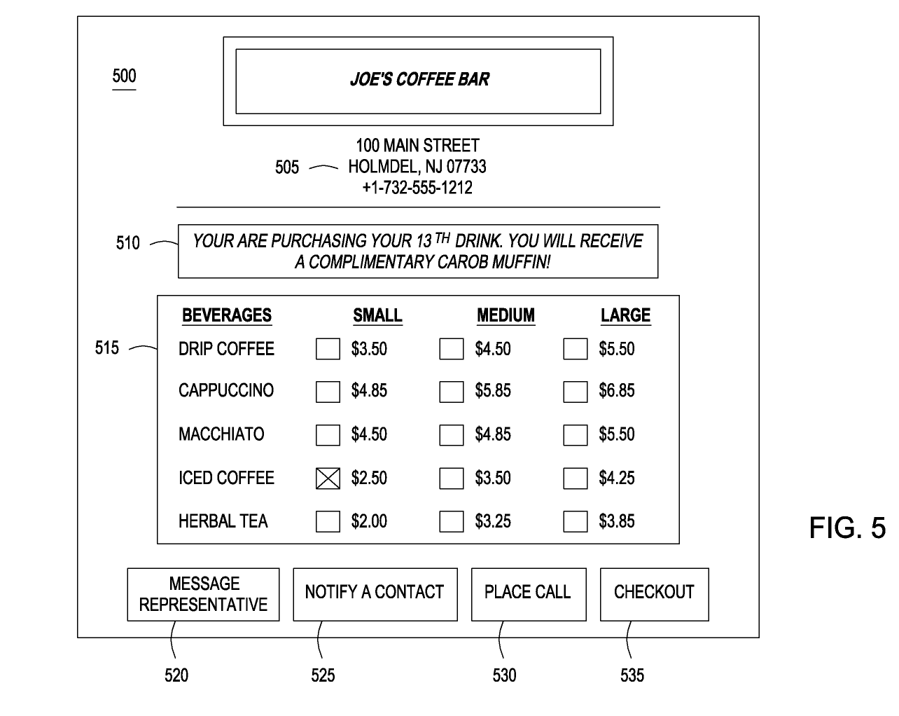

FIG. 5 is an exemplary interactive business card 500 rendered on the user device in accordance with one or more embodiments of the present invention.

The interactive business card comprises generic business data 505, promotional data 510, selectable, menu of offerings 515, a messaging option 520, a notification option 525 to notify another user device, a call option 530 to call the business entity, and a checkout option 535 to finalize purchasing of selections from the menu.

The generic business data 505 includes relatively static information of the business entity 102. Generic business data 505 may comprises the address, phone number, fax number, and the like.

The promotional data 510 is retrieved from the IBC server 115 as correlated data between a user account and business data. The promotional data 510 includes personalized offerings to the user device 110 such as loyalty reward program tracking. The promotional data 510 also provides temporary deals, specials, or if necessary, a shortage of inventory.

In some embodiments, the promotional data 510 may include references to offerings from other related business entities as automatically predetermined by the IBC server 115 or manually by respective business entities. For example, of a business entity that is a coffee shop may offer deals for a doughnut store across the street. In additional embodiments, the menu of offerings 515 may be modified to include offerings from both business entities and provide a single point of selection and payment.

The selectable menu of offerings 515 is an interactive menu for selection by the user configured to accept input for specific purchases. Additional embodiments may include descriptions of each offering.

In some embodiments, the IBC 500 includes a messaging option 520 that opens a real time communication channel such as a chat room or text message to an associate of the business entity 102. The communication channel is established using an underlying communication application installed on the user device 110. The communication application is configured to process the interactive business card. A similar function is used for the option 530 to call the business entity. For example, a VoIP communication application may integrate the received interactive business card such that communication links are connected through the VoIP communication application.

In some embodiments, the IBC 500 includes the notification option 525 to notify another user device from an address book/contact list associated with the user device 110. The notification can be to a predetermined group of users. In other embodiments, the notification may also be automatically triggered when the user device 110 location is detected as within proximity of the business entity 102. Similarly, the user device 110 may also forward the IBC 500 to the other user devices to make a selection.

The checkout option 535 sends the menu item selections to either the IBC server 115 or business entity 102. In some embodiments, the selections may be formatted for additional processing at the respective IBC server 115 or business entity 102. Upon successful checkout, the IBC server 115 and/or business entity 102 may send a confirmation code, number, or QR code to the user device 110.

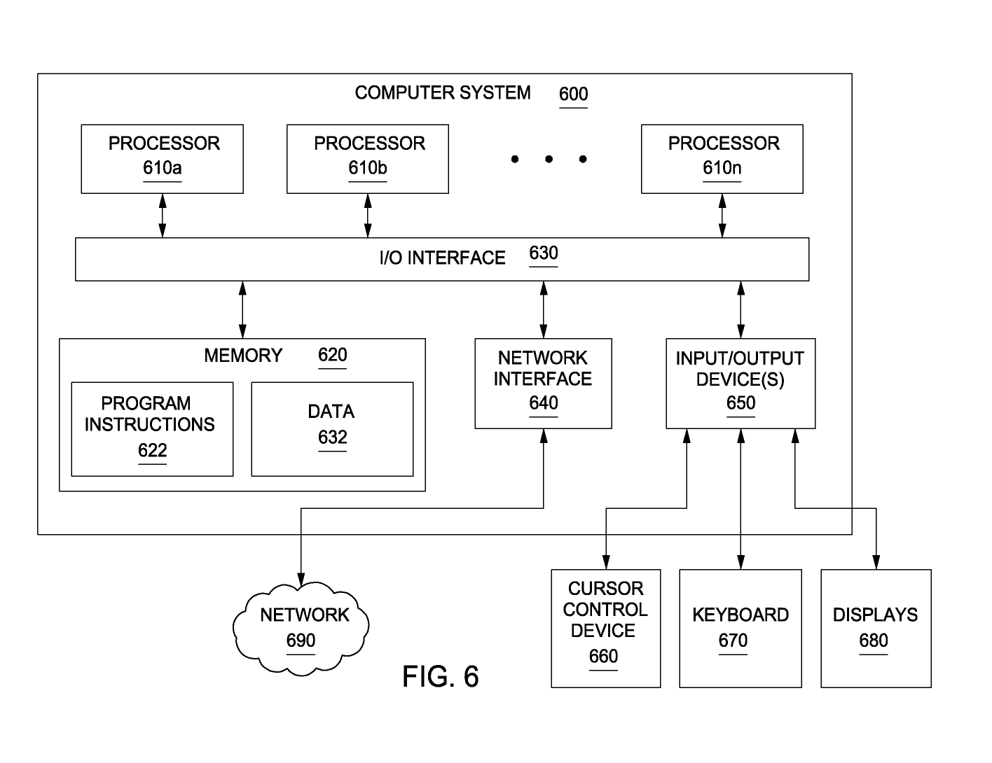

FIG. 6 is an exemplary diagram of a computer system 600 for offering services associated with a shared access point in accordance to one or more embodiments of the present invention. The computer system 600 includes substantially similar structure comprising servers or electronic devices in the aforementioned embodiments.

Various embodiments of methods and system authenticating users for communication sessions, as described herein, may be executed on one or more computer systems, which may interact with various other devices. One such computer system is computer system 600 illustrated by FIG. 6, which may in various embodiments implement any of the elements or functionality illustrated in FIGS. 1-5. In various embodiments, computer system 600 may be configured to implement methods described above. The computer system 600 may be used to implement any other system, device, element, functionality or method of the above-described embodiments. In the illustrated embodiments, computer system 600 may be configured to implement methods 300 and 400, and variations thereof as processor-executable executable program instructions 622 (e.g., program instructions executable by processor(s) 610) in various embodiments.

In the illustrated embodiment, computer system 600 includes one or more processors 610a-610n coupled to a system memory 620 via an input/output (I/O) interface 630. Computer system 600 further includes a network interface 640 coupled to I/O interface 630, and one or more input/output devices 660, such as cursor control device 660, keyboard 670, and display(s) 680. In some embodiments, the keyboard 670 may be a touchscreen input device.

In various embodiments, any of the components may be utilized by the system to authenticate a user as described above. In various embodiments, a user interface may be generated and displayed on display 680. In some cases, it is contemplated that embodiments may be implemented using a single instance of computer system 600, while in other embodiments multiple such systems, or multiple nodes making up computer system 600, may be configured to host different portions or instances of various embodiments. For example, in one embodiment some elements may be implemented via one or more nodes of computer system 600 that are distinct from those nodes implementing other elements. In another example, multiple nodes may implement computer system 600 in a distributed manner.

In different embodiments, computer system 600 may be any of various types of devices, including, but not limited to, personal computer systems, mainframe computer systems, handheld computers, workstations, network computers, application servers, storage devices, a peripheral devices such as a switch, modem, router, or in general any type of computing or electronic device.

In various embodiments, computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments processors 610 may be general-purpose or embedded processors implementing any of a variety of instruction set architectures (ISAs). In multiprocessor systems, each of processors 610 may commonly, but not necessarily, implement the same ISA.

System memory 620 may be configured to store program instructions 622 and/or data 632 accessible by processor 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 620. In other embodiments, program instructions and/or data may be received, sent or stored upon different types of computer-accessible media or on similar media separate from system memory 620 or computer system 600.

In one embodiment, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., network 690), such as one or more external systems or between nodes of computer system 600. In various embodiments, network 690 may include one or more networks including but not limited to Local Area Networks (LANs) (e.g., an Ethernet or corporate network), Wide Area Networks (WANs) (e.g., the Internet), wireless data networks, cellular networks, Wi-Fi, some other electronic data network, or some combination thereof. In various embodiments, network interface 640 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 650 may, in some embodiments, include one or more display devices, keyboards, keypads, cameras, touchpads, touchscreens, scanning devices, voice or optical recognition devices, or any other devices suitable for entering or accessing data by one or more computer systems 600. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In some embodiments, the illustrated computer system may implement any of the methods described above, such as the methods illustrated by the flowchart of FIGS. 3 and 4, and combinations thereof. In other embodiments, different elements and data may be included.

Those skilled in the art will appreciate that computer system 600 is merely illustrative and is not intended to limit the scope of embodiments. In particular, the computer system and devices may include any combination of hardware or software that can perform the indicated functions of various embodiments, including computers, network devices, Internet appliances, smartphones, tablets, PDAs, wireless phones, pagers, and the like. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for providing information and services to a user device, the method comprising:
receiving, by an interactive business card server of a service provider, information from each of a plurality of business entities via an application programming interface (API);
receiving a first set of information associated with a user device from a service provider application installed on the user device and registered with the service provider;
determining that the user device is in geographic proximity of one of the plurality of business entities based on the information received; and
sending an interactive business card including at least some of the information associated with the one of the plurality of business entities in a format that can be displayed by the service provider application.

2. The method of claim 1, wherein service provider is a Voice over Internet Protocol (VoIP) service provider and wherein the service provider application is a VoIP telecommunication application.

3. The method of claim 1, wherein the first set of information received includes user account information to authenticate a user account to access services of the service provider, and geolocation information associated with the user device.

4. The method of claim 3, wherein prior to determining that the user device is in geographic proximity of one of the plurality of business entities, the method further comprises:
authenticating the user account associated with the service provider.

5. The method of claim 3, wherein determining that the user device is in geographic proximity of one of the plurality of business entities is based on the geolocation information received.

6. The method of claim 5, wherein geographic proximity is determined using geo-fencing.

7. The method of claim 1, wherein the first set of information further includes a unique identifier of a wireless access point associated with the one of the plurality of business entities, and wherein determining that the user device is in geographic proximity of the one of the plurality of business entities includes looking up business entity information associated with the unique identifier of the wireless access point.

8. The method of claim 1, wherein the interactive business card comprises one or more offerings by the business entity including at least one of restaurant menu offerings, service offerings, food offerings, promotions, contact information, and loyalty program offerings.

9. The method of claim 8, further comprising:
receiving a selection of at least one offering; and
receiving payment information associated with the at least one offering selected.

10. The method of claim 9, further comprising:
notifying the business entity and the user device that payment has been successfully completed.

11. The method of claim 1, further comprising:
receiving a second set of information from the service provider application disposed on the user device;
determining that the user device is in geographic proximity of a second one of the plurality of business entities based on the information received;
generating an interactive business card based on the information associated with the second one of the plurality of business entities; and
sending the interactive business card to the user device in a format that can be displayed by the service provider application.

12. A method for receiving information and service associated with one or more business entities, the method comprising:
establishing, via a first user device, a wireless connection with a network access point associated with a first business entity;
sending, by a service provider application installed on the first user device, user identification information and geolocation information to a remote server via the wireless connection;
receiving, by the service provider application, an interactive business card including information or services associated with the first business entity; and
displaying, using the service provider application, the interactive business card received.

13. The method of claim 12, further comprising:
sending a notification to each of a plurality of affiliate user devices indicating that a user of the first user device is located in geographic proximity of the first business entity.

14. The method of claim 12, wherein the interactive business card includes at least one of a voice call option to call the first business entity, a text chat communication option to send a text to the first business entity, or video communication option to begin a video session with the first business entity.

15. The method of claim 14, wherein selection of the voice call option initiates a voice over internet protocol (VoIP) call to a telephone number associated with the business entity.

16. The method of claim 12, wherein the interactive business card is stored on the user device.

17. The method of claim 12, further comprising:
sending the received interactive business card to one or more user devices.

18. The method of claim 12, wherein the interactive business card comprises at least one of restaurant menu offerings, food offerings, promotions, contact information, and loyalty offerings.

19. A system for providing information and services to a user device, comprising:
an interactive business card application programming interface (API) configured to receive information from each of a plurality of business entities; and
an interactive business card generation module configured to:
receive a first set of information associated with a user device from a service provider application installed on the user device and registered with a service provider;
determine that the user device is in geographic proximity of one of the plurality of business entities based on the information received; and
send an interactive business card including at least some of the information associated with the one of the plurality of business entities in a format that can be displayed by the service provider application.

20. The system of claim 19, further comprising:
an authentication module configured to authenticate user accounts and grant access to services of a service provider.
